(19) United States
(12) Patent Application Publication
(10) Pub. No.: US 2011/0297735 A1
(43) Pub. Date: Dec. 8, 2011

(54) METHOD AND APPARATUS FOR STENT MANUFACTURING ASSEMBLY

(75) Inventors: Eran KAPLAN, Rehovot (IL); Oded STEIN, Kfar Hahoresh (IL)

(73) Assignee: MEDINOL, LTD., Tel Aviv (IL)

(21) Appl. No.: 12/791,999

(22) Filed: Jun. 2, 2010

(51) Int. Cl. B23K 31/02; B23Q 3/00

(52) U.S. Cl. 228/173.2; 269/287

(57) ABSTRACT

A stent manufacturing assembly for assisting in the manufacturing of a medical stent and a process for manufacturing a medical stent are disclosed. A patterned sheet of metal can be wrapped around the manufacturing assembly's outer surface. The assembly includes a mandrel and a sleeve. The mandrel includes a rigid and substantially cylindrical external surface, and the sleeve surrounds the mandrel and has a variable inner diameter. The sleeve adheres to the inner surface of the stent formed around the sleeve to allow the sleeve to remain in place. After the mandrel is slidably removed from the sleeve, the sleeve radially collapses and contracts, thereby causing minimal shear stress on the stent's inner surface and preventing or minimizing friction and pressure between the mandrel and the stent.

### FIELD OF THE INVENTION

The present invention relates generally to medical stents, and particularly to a stent manufacturing assembly used in a method of manufacturing stents.

### BACKGROUND OF THE INVENTION

In various medical procedures such as, for example, coronary angioplasty, a balloon is inflated within the lumen of a narrowed blood vessel in order to widen the vessel for improved blood flow. A stent, generally tubular in shape, is then inserted to permanently hold open and support the vessel. The stent is initially inserted in its relatively small, crimped state on the end of a medical catheter, and the catheter directs the stent through the lumen of a vessel to the intended implantation site. After reaching its intended implantation site, the stent is expanded to its larger diameter.

Although stents can be manufactured by several methods, one method is to cut a pattern into a metal tube using a laser. In this method, portions of a wall of a tube made of biocompatible metal are cut away such that the remaining material forms a mesh-like tube. The method requires that the pattern be cut into each tube individually. One of the disadvantages of this method is the inefficiency of individually cutting a pattern into each tube. Another disadvantage is that the interior surface of the resulting stent cannot be adequately inspected, and defects on this surface are incorporated into the final stent. Such defects compromise the integrity of the stent.

In another method of stent manufacturing, a mandrel is employed in order to fold a sheet of metal, for example, into a tubular shape. In this method, a sheet having a plurality of stent patterns is laser-cut in a single step. The individual stent patterns can be easily inspected on both sides of the sheet before folding the sheet into a stent. Each pattern is then deformed around a cylindrical mandrel such that each pattern is forced to take on the shape of the mandrel. The edges of the pattern are then brought together and welded, the mandrel is removed, and a tubular stent having the pattern that provides the desired strength and flexibility is the resulting product. The method employing a mandrel is superior to other methods, because (1) a pattern can be easily cut into a flat sheet, (2) both sides of the patterned sheet can be inspected prior to deformation, and (3) the method is highly efficient.

However, one problem with the method employing a mandrel is that the contact between the mandrel and the internal surface of the patterned sheet (the stent), during removal of the mandrel, can result in damage to the internal surface of the sheet. In addition, stents are often coated with a special polymer, a drug, or a combination thereof. Deformation of the sheet and removal of the mandrel can cause damage to the integrity of the coated surface material by the contact, friction, and/or pressure between the mandrel and the inner surface of the stent. Although an attempted solution to such a problem may involve providing a soft coating on the mandrel to minimize the friction and pressure, this fails to effectively solve the problem because, e.g., the soft coating may melt during the welding process, causing the coating to adhere to the coated stent.

In light of the foregoing, one object of the invention is to provide an apparatus and method for protecting the internal surface of the stent during its manufacturing process. Another object is to provide a mandrel surface that will not damage or compromise the integrity of the interior surface of the stent.

### SUMMARY OF THE INVENTION

The present invention is directed to a stent manufacturing assembly and a method by which the assembly can be employed in manufacturing a stent. In particular, the present invention provides a method and apparatus for assembling a stent from a flat sheet wherein the stent manufacturing assembly includes a mandrel surrounded by a removable sleeve. The sleeve adheres to the inside of the patterned metal sheet as the sheet is deformed around the assembly to form a stent. The adherence allows the sleeve to remain in position during mandrel removal. The sleeve may comprise a flexible material stable at high temperatures and may also have a variable inner diameter, e.g., contractable or expandable. The mandrel is made of metal and has a rigid and substantially cylindrical external surface. As the mandrel is slidably removed from the sleeve, the sleeve resorts from a working diameter to a resting diameter and is radially collapsed from the stent, thereby causing minimal shear stress on the stent's inner surface and preventing or minimizing friction and pressure between the sleeve and the stent.

The invention also relates to a method of manufacturing a stent using the stent manufacturing assembly to allow a sheet of material to be formed into a stent. In an embodiment of the invention, the method may comprise, for example, contacting a sleeve with a mandrel such that the sleeve is secured on the mandrel; contacting the sleeve with a patterned metal sheet; and folding or wrapping the sheet around the assembly by a method such as, for example, the method identified in U.S. Pat. No. 7,208,009. The method may further comprise welding the edges of the patterned sheet to form a stent around the assembly, and slidably removing the mandrel from the sleeve, for example, by pushing or pulling the mandrel longitudinally. After the mandrel has been removed from the sleeve, the method further comprises separating the sleeve from the stent, for example, by compression of the sleeve to its resting diameter.

### BRIEF DESCRIPTION OF THE DRAWINGS

FIG. 1 is an elevational view of a stent manufacturing assembly in accordance with an embodiment of the invention.

FIG. 2 is another view of a stent manufacturing assembly in accordance with an embodiment of the invention.

FIG. 3 is a transverse view of the stent manufacturing assembly shown in FIG. 1, taken along line 3-3, in accordance with an embodiment of the invention.

FIG. 4 is a transverse view of an alternative embodiment of the stent manufacturing assembly.

FIG. 5 illustrates the stent manufacturing assembly in conjunction with a patterned metal sheet prior to stent formation in accordance with an embodiment of the invention.

FIG. 6 illustrates a finished stent and a collapsed sleeve inside the stent after the stent manufacturing assembly is employed in accordance with an embodiment of the invention.

FIG. 7 illustrates a stent manufacturing assembly in which the mandrel has an embossed longitudinal subsection that projects to the outer diameter of the sleeve.

FIG. 8 illustrates a stent manufacturing assembly in which the sleeve has a helical cut that allows the diameter of the sleeve to be contracted in accordance with another alternative embodiment of the invention.

FIG. 9 illustrates the embodiment of the invention depicted in FIG. 8 after removal of the mandrel and contraction of the sleeve's diameter.

### DETAILED DESCRIPTION OF THE INVENTION

The present invention is directed to a stent manufacturing assembly and a method of forming a stent using the stent manufacturing assembly.

The stent manufacturing assembly of the invention comprises a mandrel with a rigid and substantially cylindrical external surface and a tubular sleeve surrounding the mandrel and conforming to its shape. The sleeve provides a buffer between the surface of the mandrel and the surface of the sheet as the patterned sheet is formed into a stent. The sleeve is cylindrical or partially cylindrical in shape and is defined by an inner diameter that may vary between a resting diameter and a working diameter, that is, a contractable inner diameter.

As used herein, the term “resting diameter” refers to the diameter of the sleeve when no force is applied to it, for example, before the sleeve is placed over the mandrel. In contrast, the term “working diameter” refers to the diameter of the sleeve after force is exerted thereon, for example, when the sleeve is placed over the cylindrical surface of the mandrel and the patterned metal sheet has been wrapped around the mandrel. In one embodiment of the invention, the resting diameter of the sleeve is smaller than the working diameter of the sleeve. In this embodiment, the sleeve is expanded when positioned on the mandrel. The variability of the inner diameter of the sleeve provides the advantage of separating the sleeve from the stent without damaging the interior surface of the stent. The separation of the sleeve from the interior stent surface preferably occurs after the mandrel is longitudinally removed from the sleeve.

The mandrel can be made of any rigid material possessing a high melting point, a high strength and hardness, and/or high thermal conductivity, for example, any of the suitable metals. Non-limiting examples of such metals include silver, copper and stainless steel. The thermal conductivity of the mandrel may range from about 8 W/m°K (stainless steel) to approximately 420 W/m°K (Copper, Silver), for example. The diameter of the mandrel may vary depending on the type of stent being manufactured. Certain stents require, for example, a mandrel having a diameter in the range from 0.5 mm to 3.0 mm. The length of the mandrel may be approximately 1.8 mm, for example. The diameter and length of the mandrel are determined by the desired diameter of the stent to be manufactured. One of ordinary skill in the relevant art will recognize that other diameter and length specifications may be utilized without departing from the spirit and scope of the invention.

The sleeve can be made of any flexible, rigid, or semi-rigid polymer. Examples of such polymers include polypropylene, polyethylene, polytetrafluoroethylene (PTFE), expanded polytetrafluoroethylene (ePTFE), perfluoroalkoxy polymer resin (PFA), and fluorinated ethylene-propylene (FEP). The sleeve may also be made of shape memory polymers or heat shrinkable polymers. It should also be noted that the sleeve thickness will vary depending on the material employed and the process manufacturing steps used. For example, the sleeve may be 0.1 mm thick in one embodiment. The thickness of the sleeve may, for example, range from 0.05 mm to 0.3 mm or more. Preferred sleeve thickness is 0.1 mm. The length of the sleeve varies depending on the type of stent being manufactured. For example, the length may vary from about 0.5 mm for certain coronary stents to about 30 mm for certain peripheral stents. Preferred lengths include, for example, 1.3 mm and 1.8 mm. However, one of ordinary skill in the relevant art will recognize that other sleeve dimensions may be utilized without departing from the spirit and scope of the invention.

The stent manufacturing assembly facilitates formation of a stent from a patterned metal sheet according to various known methods, such as, for example, the method described in U.S. Pat. No. 7,208,009. In such a method, after the patterned sheet is formed into a tube by wrapping the sheet around the stent manufacturing assembly, the edges of the patterned sheet are welded, thereby forming a stent. In one embodiment, the sleeve physically adheres to the interior surface of the stent due to surface contact (e.g., surface tackiness) and friction, for example, after stent formation, which causes the sleeve to remain on the stent as the mandrel is removed. Once the mandrel has been removed, the internal tension of the sleeve is released and the sleeve returns to its smaller resting diameter, thereby allowing the sleeve to be separated from the stent.

In one embodiment, the sleeve contains a longitudinal cut that allows the sleeve to be expanded from its smaller resting diameter to its larger working diameter. As used herein, the term “longitudinal cut” refers to space between the lengthwise edges of a tubular sleeve. The lengthwise edges may contact each other, for example, when the sleeve is in its resting diameter and may be separated such that they do not contact one another when the sleeve is in its working diameter. In this embodiment, the longitudinal cut may align with the joined edges of the patterned metal sheet after the patterned metal sheet has been folded around the mandrel. The edges may then be welded in alignment along the longitudinal cut such that these edges do not contact the sleeve. In an alternative embodiment of the invention, the edges of the sleeve may also contact each other when the sleeve is in its working diameter after having expanded from a resting diameter in which the edges overlap, for example. In yet another embodiment, the sleeve is an elastic, tubular sleeve without a cut. In such an embodiment, the elasticity allows the sleeve to expand as necessary from its resting diameter to its working diameter. Elastic sleeves may comprise, for example, polychloroprene, silicone rubber, or PTFE-coated rubber.

In another alternative embodiment, the sleeve may have a longitudinal cut, and the mandrel may have an embossed longitudinal subsection that projects from the surface of the mandrel to the outer diameter of the sleeve. That is, the surface of the embossed longitudinal subsection is substantially level with the outer surface of the sleeve. The embossed longitudinal subsection of the mandrel may occupy the space between the edges of the sleeve. The surface of the embossed longitudinal subsection provides a solid surface on which to weld the edges of the patterned metal sheet after the sheet is folded into the stent.

The aforementioned embodiments, as well as other embodiments, are discussed and explained below with reference to the accompanying drawings. Note that the drawings are provided as an exemplary understanding of the invention and to schematically illustrate particular embodiments of the invention. The skilled person will readily recognize other similar examples are equally within the scope of the invention. The drawings are not intended to limit the scope of the invention defined in the appended claims.

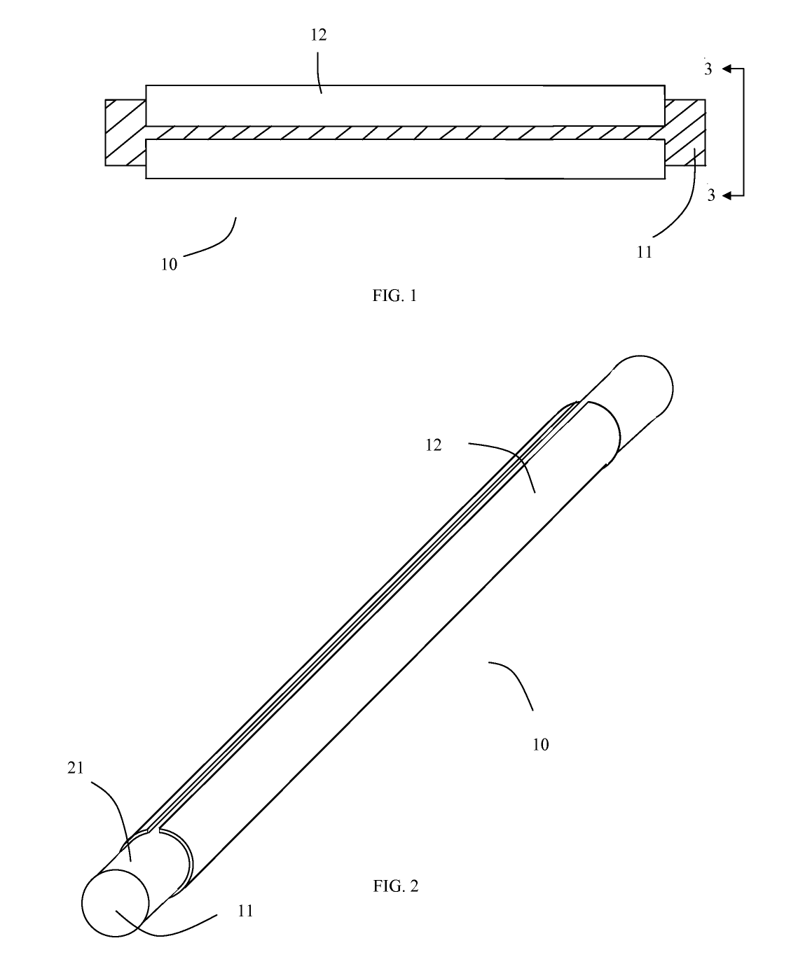

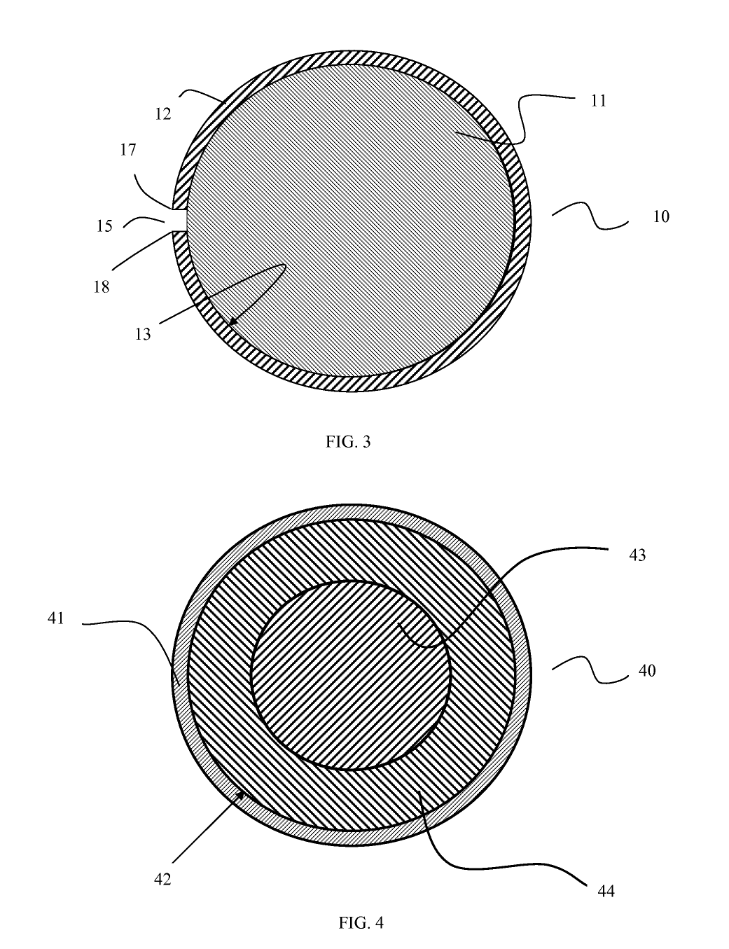

FIG. 1 illustrates a stent manufacturing assembly 10, embodying features of one embodiment of the invention. In this embodiment, the sleeve is shorter than the mandrel and longer than the stent such that the end portions of the mandrel are partially exposed when the sleeve and the mandrel are assembled. This configuration allows the mandrel to be longitudinally displaced while the sleeve is held in place. The stent manufacturing assembly 10 generally comprises a mandrel 11 and a tubular sleeve 12 surrounding the mandrel 11. In the embodiment illustrated in FIG. 1, the length of the sleeve 12 is shorter than the length of the mandrel 11. The mandrel 11 is rigid and generally substantially cylindrical in shape and comprises a material containing high thermal conductivity, a high melting point, and a high strength and hardness. FIG. 2 represents a different view of the stent manufacturing assembly 10 illustrated in FIG. 1. FIG. 2 additionally illustrates the external surface 21 of the mandrel 11 as covered by the sleeve 12.

FIG. 3 is a transverse view of the stent manufacturing assembly 10 of FIG. 1 taken from line 3-3. The mandrel 11 includes an outer diameter 13. In one embodiment of the invention, the resting diameter of the sleeve 12 is smaller than the outer diameter 13 of the mandrel 11. Although the mandrel 11 is illustrated as being composed of one single layer, it should be noted that the mandrel 11 may also be composed of a plurality of layers, for example, an internal and external layer. In the illustrated embodiment, the sleeve 12 includes the longitudinal cut 15, defined by edges 17 and 18, to allow the resting diameter of the tubular sleeve 12 to be expanded to the working diameter of the sleeve 12 upon mandrel insertion. Before expansion of the sleeve 12 to its working diameter, the edges 17 and 18 defining the cut 15 may contact each other, overlap, or not contact each other. If the edges contact each other before expansion, the edges 17 and 18 are temporarily moved away from each other during expansion such that the edges are not in contact, as illustrated in FIG. 3.

Alternatively, if the edges overlap before the sleeve is fitted onto the mandrel, the overlap will be reduced or eliminated when the sleeve is fitted on the mandrel. In these embodiments, if the edges are not in contact before the sleeve is fitted onto the mandrel, the distance between the edges may be increased upon insertion of the mandrel.

In general, the sleeve's actual resting and working diameters will be determined based upon the diameter of the mandrel. In one embodiment, the sleeve 12 adheres to the inside surface of the stent during stent formation. For example, the sleeve can physically adhere to the inside surface of the stent due to contact and friction. After the patterned sheet is deformed around the stent manufacturing assembly and the edges are welded, a stent is formed. Then, the mandrel 11 is slidably removed from the sleeve 12 while the sleeve is manually held in place, causing the sleeve to stay in place relative to the stent. At this point, the sleeve radially collapses: That is, at this point, internal tension of the sleeve 12 is released as the working diameter of the sleeve 12 resorts to the resting diameter of the sleeve 12. The removal of the mandrel and the radial collapsing motion of the sleeve 12 apply minimal shear stress on the stent's inner surface. This feature of the invention minimizes and/or prevents problems involved in prior stent manufacturing methods, such as friction and pressure between the mandrel and the inner surface of the stent.

FIG. 4 illustrates an alternative embodiment of the invention also shown as a transverse view. As illustrated in FIG. 4, the stent manufacturing assembly 40 may be comprised of a continuous tubular sleeve 41 and a mandrel 42. In the alternative embodiment depicted in FIG. 4, the sleeve 41 is a continuous elastic tubular sleeve without a cut or edges, in contrast to the embodiment illustrated in FIG. 3. In this embodiment, the diameter of the sleeve varies from the sleeve's resting diameter to its working diameter when it is stretched by the insertion of the mandrel. Depending upon the degree of elasticity of the sleeve material, the diameter of the sleeve 12 will vary between its resting and working diameters. Sleeve 41 adheres to the interior surface of the stent during stent formation, as in FIG. 3.

Further, the mandrel 42 shown in FIG. 4 also separately illustrates an embodiment that may further include an internal core 43 and an external layer 44, with the internal core 43 being made of rigid metal and the external layer 44 containing a metal having a high degree of thermal conductivity. In one embodiment, the internal core 43 may be hardened steel, tungsten, cast iron, or manganese. The rigidness of the internal core provides increased stiffness of the assembly. The external layer 44 may contain metals such as silver, copper, brass, gold, or platinum for example. Based upon the instant disclosure, one of ordinary skill in the relevant art will readily appreciate that other configurations and materials may be utilized without departing from the scope and spirit of the invention. For example, instead of silver, aluminum or rhodium may be used for the external layer 44. Similarly, instead of an internal core 43 and an external layer 44, the mandrel 42 may include only one layer, as described in FIG. 1, or a plurality of layers and/or cores, for example two or more layers.

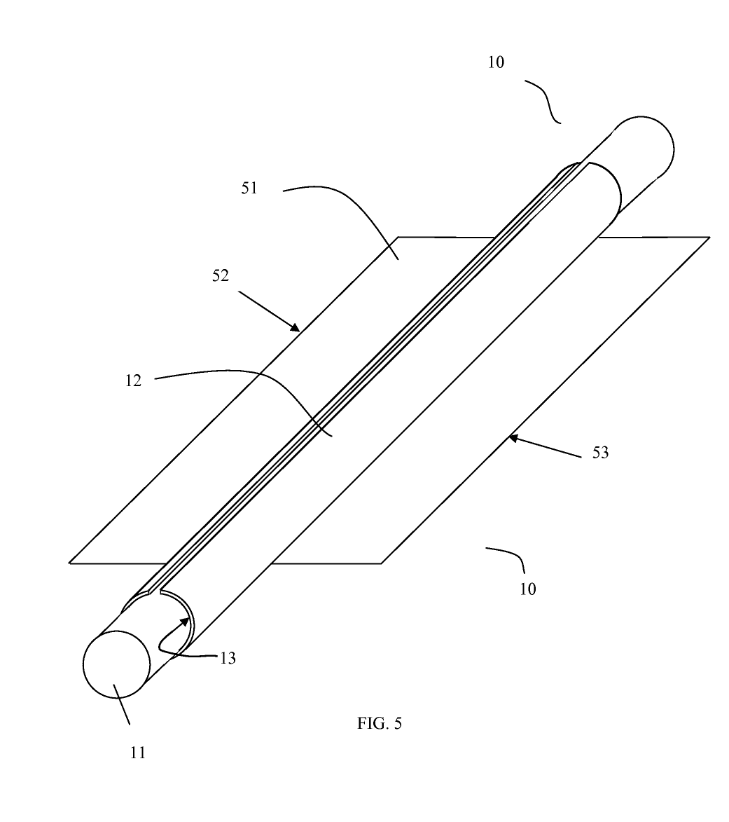

FIG. 5 illustrates a stent manufacturing assembly 10 according to the invention and a patterned sheet 51 before the sheet 51 is folded into a stent. The patterned sheet 51 has a first edge 52 and a second edge 53. After the sheet 51 is folded into a stent, the first edge 51 and second edge 52 of the sheet are joined by a welding process, for example, as would be known by one of ordinary skill in the art, for example, as described in U.S. Pat. No. 7,208,009, the welding process incorporated herein in toto by reference. After the sheet has been folded around the mandrel, the edges of the sheet are welded to each other and reside over the gap in the sleeve, thereby preventing actual contact of the molten edges of the stent with the sleeve. As such, the sleeve is not inadvertently damaged by the edges of the sheet.

In this embodiment, the length of the sleeve 12 is shorter than the mandrel 11, and the patterned metal sheet 51 is shorter than the sleeve 12. That is, the edges 52 and 53 are shorter than the long axis of the sleeve 12. As such, while the sleeve is held in place, longitudinal force can be applied to the mandrel to remove the mandrel from the sleeve, thereby allowing the sleeve to remain adhered to the stent. This feature allows the inner surface of the sleeve to absorb the friction caused by the removal of the mandrel.

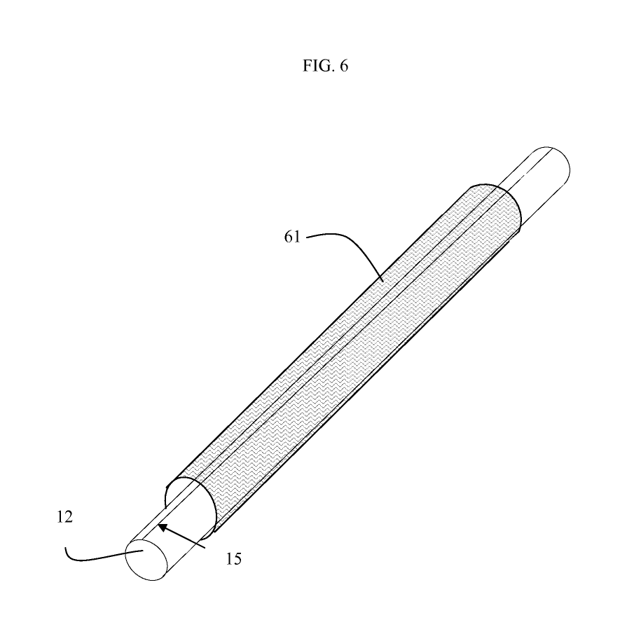

FIG. 6 illustrates the sleeve 12 situated within the fully formed stent 61. In FIG. 6, the mandrel (11 in FIG. 5) has been removed from the sleeve 12 and the sleeve 12 is radially collapsed from the stent. The removal and collapsing processes occur in a manner that applies minimal shear stress on the stent's 61 inner surface.

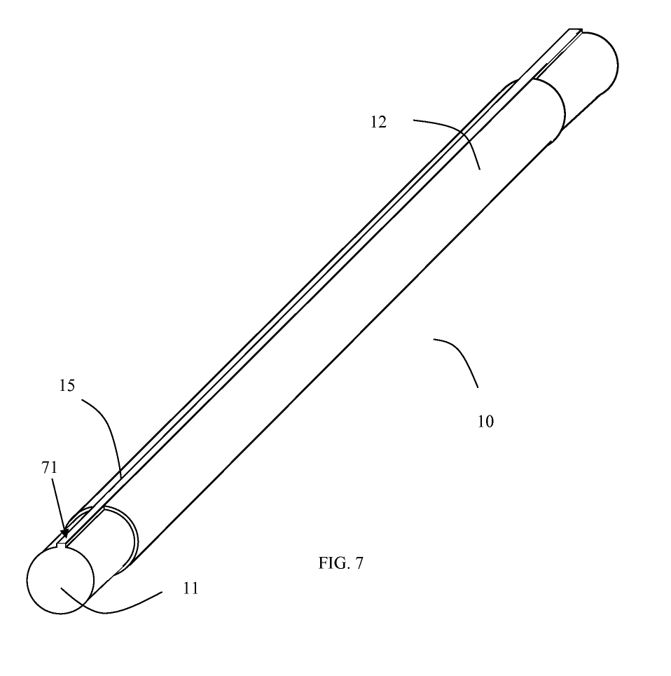

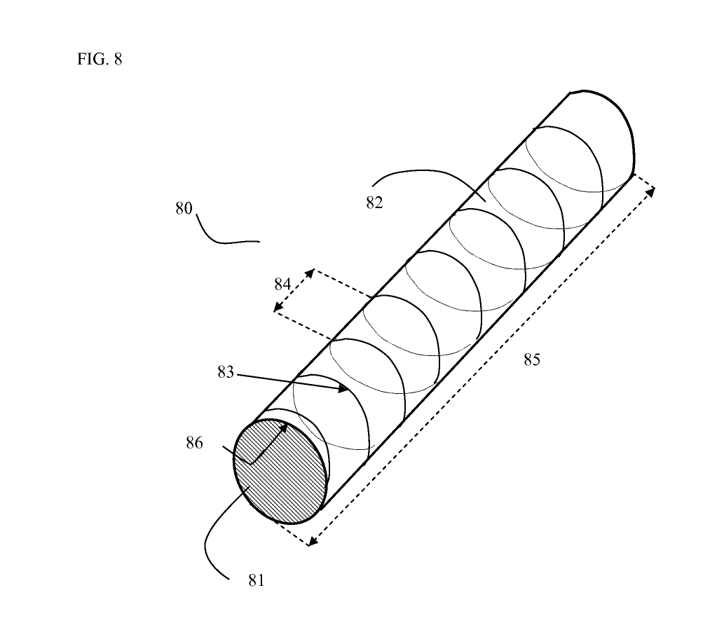

FIG. 7 illustrates another alternative embodiment of the stent manufacturing assembly 10 in which the sleeve 12 has a longitudinal cut 15. The mandrel 11 has an embossed longitudinal subsection 71 that projects from the surface of the mandrel 11, as illustrated in FIG. 7. The embossed longitudinal subsection 71 may have a width that is equal to or smaller than the distance between the edges of the sheet such that the embossed longitudinal subsection substantially occupies the space defined by the longitudinal cut 15. During stent formation, the edges of the patterned metal sheet are aligned over the longitudinal subsection such that the subsection serves as a backing for the points at which the edges of the sheet are welded to one another.

FIG. 8 illustrates another alternative embodiment in which a stent manufacturing assembly 80 comprises a mandrel 81, which is situated within and is slidably removable from the sleeve 82. The sleeve 82 has a continuous helical cut 83. As illustrated, the helical cut 83 is oriented to the left, but a helical cut oriented to the right is equally effective. The pitch 84 of the helical cut 83 may be varied as desired for a particular use. As illustrated, the pitch 84 is equal to the length 85 of the sleeve 82 divided by eight. When the mandrel 81 is removed, torsion may be applied to one or both ends of the sleeve 82, thereby causing the diameter 86 of the sleeve 82 to contract, as the edges of the helical cut 83 slide with respect to each other. The resting diameter of the sleeve in this embodiment is exhibited when the sleeve 82 surrounds the mandrel 81, before torsion is applied. The working diameter is exhibited when torsion is applied to the sleeve 82, thereby resulting in a reduction of the sleeve's diameter. Therefore, in the illustrated embodiment, the sleeve's resting diameter is larger than its working diameter. The helical cut sleeve may alternatively have a resting and working diameter similar to any of the embodiments described herein above.

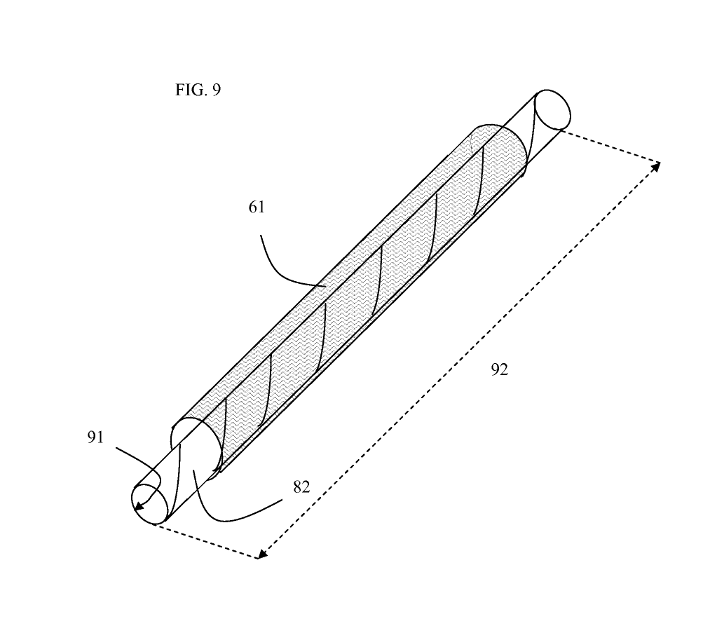

FIG. 9 illustrates a contracted helical-cut sleeve 82 situated within a finished stent 61 after the mandrel (81 in FIG. 8) has been removed and the sleeve 82 has undergone torsion. The diameter 91 of the sleeve 82 is now smaller than the diameter of the stent 61 as well as the diameter 86 of the sleeve 82 depicted in FIG. 8. The length 92 of the sleeve 82 may be greater upon contraction, or the edges of the helical cut 83 may overlap. The reduction in sleeve diameter causes the sleeve 82 to separate from the stent 61 in a manner that minimizes or prevents the interior stent surface from experiencing potentially harmful shear forces.

The invention also relates to a method of manufacturing a stent using a stent manufacturing assembly. In this embodiment of the invention, the method may comprise, for example, contacting a sleeve 12 with a mandrel 11 such that the sleeve is secured on the mandrel; contacting the sleeve with a patterned metal sheet; and folding or wrapping the sheet around the assembly by a method, one such example method is identified in U.S. Pat. No. 7,208,009. Securement of the sleeve to the mandrel may be accomplished by the elasticity of the sleeve material, shape memory materials, mechanical force applied to the sleeve, or the like. The method further comprises welding the edges of the patterned sheet to form a stent (e.g., 61 in FIG. 6), and slidably removing the mandrel from the sleeve. When the sleeve is held and the mandrel is longitudinally removed from the sleeve, the sleeve remains adhered to the stent. That is, the sleeve may stay in place relative to the stent, for example, by holding the sleeve while displacing the mandrel. After slidably removing the mandrel from the sleeve, the method further comprises separating the sleeve from the stent, for example, by compression of the sleeve from its working diameter to its resting diameter, e.g., as illustrated in FIG. 6 or FIG. 8. Alternatively, the sleeve may be compressed by the application of external force. The compressed sleeve may then be removed longitudinally from the stent.

While various embodiments of the present invention have been described above, it should be understood that they have been presented by way of example only, and not by way of limitation. Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1) A stent manufacturing assembly, comprising:
a mandrel having a rigid and substantially cylindrical external surface; and
a sleeve surrounding said mandrel, said sleeve having a variable inner diameter.

2) The stent manufacturing assembly of claim 1 wherein said sleeve is shorter in length than said mandrel.

3) The stent manufacturing assembly of claim 1 wherein said sleeve has edges comprising a longitudinal cut.

4) The stent manufacturing assembly of claim 3 wherein said mandrel has an embossed longitudinal subsection that projects from said external surface of said mandrel.

5) The stent manufacturing assembly of claim 1 wherein said sleeve has edges comprising a helical cut.

6) The stent manufacturing assembly of claim 1 wherein said mandrel comprises a metal.

7) The stent manufacturing assembly of claim 1 wherein said mandrel includes a plurality of layers.

8) The stent manufacturing assembly of claim 7, wherein each of said plurality of layers comprises a composition.

9) The stent manufacturing assembly of claim 8, wherein said composition varies between said plurality of layers.

10) The stent manufacturing assembly of claim 1 wherein said mandrel has an internal core and an external layer.

11) The stent manufacturing assembly of claim 10 wherein said external layer has a high degree of thermal conductivity.

12) The stent manufacturing assembly of claim 10 wherein said internal core is hardened steel.

13) The stent manufacturing assembly of claim 1 wherein said sleeve is a flexible, rigid or semi-rigid polymer.

14) The stent manufacturing assembly of claim 1 wherein said sleeve has an inner resting diameter and said mandrel has an outer diameter, said inner resting diameter of said sleeve being smaller than said outer diameter of said mandrel, such that said sleeve is expanded when surrounding said mandrel.

15) The stent manufacturing assembly of claim 1 wherein said sleeve is 0.1 mm thick.

16) The stent manufacturing assembly of claim 1 wherein said sleeve is between 0.05 mm and 0.3 mm thick.

17) The stent manufacturing assembly of claim 1 wherein the sleeve is more than 0.3 mm.

18) A stent manufacturing aid, comprising:
a sleeve having an internal diameter, said sleeve adapted such that said internal diameter expands from a resting diameter to a working diameter, said working diameter being greater than said resting diameter represented in a resting state of said sleeve.

19) The stent manufacturing aid of claim 18, wherein said sleeve has a longitudinal cut.

20) The stent manufacturing aid of claim 18 wherein said sleeve has a helical cut.

21) The stent manufacturing aid of claim 18, wherein said sleeve is made of a type of polymer.

22) The stent manufacturing aid of claim 18, wherein said sleeve is made of polytetrafluoroethylene.

23) A method of manufacturing a stent using a stent manufacturing assembly, comprising:
contacting a sleeve with a mandrel to secure said sleeve on the mandrel;
contacting the sleeve with a patterned metal sheet;
folding said sheet around the assembly; and
welding edges of the sheet to form the stent.

24) The method of claim 23 further comprising slidably removing the mandrel from the sleeve.

25) The method of claim 24 wherein said slidably removing includes pushing or pulling the mandrel longitudinally.

26) The method of claim 23, further comprising separating the sleeve from the stent by compression of the sleeve from its working diameter to is resting diameter.

27) The method of claim 26, wherein said separating includes compressing the sleeve via the application of external force.

28) The method of claim 23, wherein said sleeve is longitudinally removed from the stent.

29) The method of claim 24 wherein said removing includes manually removing said mandrel.

30) The method of claim 24 wherein said removing includes automatically removing said mandrel.
